(19) United States
(12) Patent Application Publication
(10) Pub. No.: US 2026/0317487 A1
(43) Pub. Date: Oct. 15, 2026

(54) recyclable thermoset composition and its making process

(71) Applicant: CHANDA CHEMICAL CORP., Taipei (TW)

(72) Inventors: Chien-Hsin WU, Taipei (TW); Ying-Chi HUANG, Taipei (TW); Ho-Ching HUANG, Taipei (TW)

(21) Appl. No.: 19/645,605

(22) Filed: Apr. 13, 2026

Related U.S. Application Data
(60) Provisional application No. 63/786,991, filed on Apr. 11, 2025.

(51) Int. Cl. C08G 81/00; C08J 11/16; C08J 11/22; C08J 11/28

(52) U.S. Cl. CPC C08G 81/00; C08J 11/16; C08J 11/22; C08J 11/28; C08J 2331/02; C08J 2333/04; C08J 2361/10; C08J 2361/20; C08J 2363/00; C08J 2367/00; C08J 2371/12; C08J 2375/02; C08J 2375/04; C08J 2377/00; C08J 2379/02; C08J 2379/04; C08J 2379/08; C08J 2383/04

(57) ABSTRACT

A recyclable thermoset composition and its method are disclosed. Specifically, the recyclable thermoset composition comprises 1-50 wt. % of at least one polyester oligomer or low molecular weight polycarbonate and 50-99 wt. % of at least one thermoset resin calculated based on total weight of the recyclable thermoset composition, wherein the polyester oligomer or low molecular weight polycarbonate has a number average molecular weight (Mn) ranging from 500 to 5000 g/mol or a weight average molecular weight (Mw) ranging from 200 to 20,000 Da.

### TECHNICAL FIELD

A recyclable thermoset composition and its method are disclosed. Specifically, the recyclable thermoset composition comprises at least one polyacyloxy oligomer and at least one thermoset resin.

### BACKGROUND

Thermoset resins such as epoxy resins, phenolic resins, unsaturated polyester resins and the like are not melted by heat once they are hardened, and reuse thereof as a resin material is difficult.

Traditionally, waste thermoset resin treatment includes solvolysis, incineration, pyrolysis, mechanical grinding and their combination, however, the above treatment involves complicated operations and causes second pollutions, such as air pollution and water pollution. As so far, the development of a recyclable thermoset materials and the like is still a challenge.

Accordingly, there is a continuing need to develop a recyclable thermosets or process for treating waste thermoset materials and to achieve the goals of green chemistry and circular economy.

### SUMMARY OF THE INVENTION

In view of the above background of the invention and to meet the requirements of the industry, the invention discloses a recyclable thermoset composition, making process from waste thermoset resins and application for recycling waste thermoset resins.

Herein, polyacyloxy oligomers and low molecular weight polyacyloxy oligomers are synonym; low molecular weight polycarbonate and oligocarbonate are synonym. All of them have a number average molecular weight (Mn) ranging from 500 to 5000 g/mol or a weight average molecular weight (Mw) ranging from 200 to 20,000 Da.

Specifically, the invention not only discloses a novel recyclable thermoset composition by mixing or blending at least one polyacyloxy oligomer, low molecular weight polyester or low molecular weight polycarbonate (oligocarbonate) or their mixture into another thermoset resins but also provides an innovative solution for recycling waste thermoset resins.

In one objective, the recyclable thermoset composition that comprises polyacyloxy oligomers such as polyester oligomers or low molecular weight polycarbonates is disclosed. The polyacyloxy oligomer or low molecular weight polyester or polycarbonates assist the thermoset resin to form a homogeneous mixture in recycling process and catalyze interactions or reactions between the degrader and the thermoset resin.

In one aspect, the recyclable thermoset composition comprises 1-50 wt. % of at least one polyacyloxy oligomer such as low molecular weight polyester or polycarbonate and 50-99 wt. % of at least one thermoset resin calculated based on total weight of the recyclable thermoset composition.

In one aspect, the polyacyloxy oligomer such as low molecular weight polyester or polycarbonate has a number average molecular weight (Mn) ranging from 500 to 5000 g/mol or a weight average molecular weight (Mw) ranging 200 from 20,000 Da. In a preferred example, the polyacyloxy oligomer such as low molecular weight polyester or polycarbonate has a weight average molecular weight (Mw) between 500 and 10,000 Da.

In one aspect, the polyacyloxy oligomer such as low molecular weight polyester or polycarbonate comprises polyesters, aliphatic polycarbonates, aromatic polycarbonates or their combinations.

In one aspect, the polyacyloxy-based polyester are prepared by following reactions: (1) Transesterification route, in which an alkyl adipate is mixed with one or more glycol monomers and heated in the presence of a transesterification catalyst to promote ester-exchange and polycondensation, thereby forming a low molecular weight polyester. (2) Direct esterification (dehydration) route, in which an adipic acid or other aliphatic diacid is reacted with one or more glycol monomers under elevated temperature, while water generated during esterification is continuously removed to drive the reaction toward polyester formation.

In another aspect, the aliphatic polyacyloxy-based polycarbonates are prepared by following reactions. (1) polycondensation between an aliphatic polyol with dialkyl carbonate, (2) ring-opening polymerization (ROP) of cyclic carbonate (CC) monomers, and (3) copolymerization of CO₂ with epoxides.

In another aspect, the polyacyloxy-based aromatic polycarbonates are generally prepared by phosgenation of bisphenol A, bisphenol F or its analogues, or transesterification with carbonic acid derivatives like diphenyl carbonate which in turn are also prepared by phosgenation.

In another aspect, the thermoset resin comprises polyurethane resin, epoxy resin, phenol-formaldehyde resin, benzoxazine resin, acrylate resin, urea resin, melamine resin, polyester resin, polyimide resin, polyamides resins, bismaleimide resins, urea formaldehyde resins, vinyl ester resins, silicone resins, unsaturated polyester resin, polyphenylene oxide based thermoset resin or their combination.

In another objective, a process for making recyclable thermoset composition from waste thermoset resins is provided. The process comprises following steps.
Step 1, Decompose waste thermoset resins (via recyclable thermoset composition) in the presence of degraders to generate a decomposed product.
Step 2, Mix at least one polyester oligomer or low molecular weight polycarbonate with the decomposed product to obtain a recyclable thermoset composition.

In one aspect, the waste thermoset resin (via recyclable thermoset composition) comprises waste polyurethane resin, waste epoxy resin, waste phenol-formaldehyde resin, waste benzoxazine resin, waste acrylate resin, waste urea resin, waste melamine resin, waste polyester resin, waste polyimide resin, waste polyamides resins, waste bismaleimide resins, waste urea formaldehyde resins, waste vinyl ester resins, waste silicone resins, waste unsaturated polyester resin, waste polyphenylene oxide based thermoset resin or their combination.

In one aspect, the recyclable thermoset composition comprises 1-50 wt. % of the polyester oligomer or low molecular weight polycarbonate and 50-99 wt. % of the decomposed product based on total weight of the recyclable thermoset composition.

In one aspect, the polyester oligomer or low molecular weight polycarbonate has a number average molecular weight (Mn) ranging from 500 to 5000 g/mol or a weight average molecular weight (Mw) ranging from 500 to 20,000 Da. In a preferred example, the polyester oligomer or low molecular weight polycarbonate has a weight average molecular weight (Mw) ranging from 1,000 to 10,000 Da.

In one aspect, the low molecular weight polycarbonate comprises low molecular weight aliphatic polycarbonates, low molecular weight aromatic polycarbonates or their combinations.

In still another objective, a method for recycling waste thermoset resin is provided. Representatively, the method for recycling waste thermoset resin comprises following steps.
Step 1, decompose waste thermoset resin (via recyclable thermoset composition) in the presence of degraders to generate a decomposed product. Composition of the decomposed product comprises organic compounds and/or inorganic compounds.
Step 2, mix at least one polyester oligomer or low molecular weight polycarbonate with the decomposed product to obtain a recyclable thermoset composition.
Step 3, cure the recyclable thermoset composition to produce a regenerated thermoset resin, and achieve purpose of recycling the waste thermoset resin.

In one aspect, the waste thermoset resin (via recyclable thermoset composition) comprises waste polyurethane resin, waste epoxy resin, waste phenol-formaldehyde resin, waste benzoxazine resin, waste acrylate resin, waste urea resin, waste melamine resin, waste polyester resin, waste polyimide resin, waste polyamides resins, waste bismaleimide resins, waste urea formaldehyde resins, waste vinyl ester resins, waste silicone resins, waste unsaturated polyester resin, waste polyphenylene oxide based thermoset resin or their combination

In one aspect, the recyclable thermoset composition comprises 1-50 wt. % of the polyester oligomer or low molecular weight polycarbonate and 50-99 wt. % of the decomposed product based on total weight of the recyclable thermoset composition.

In one aspect, the polyester oligomer or low molecular weight polycarbonate has a number average molecular weight (Mn) ranging from 500 to 5000 g/mol or a weight average molecular weight (Mw) ranging from 500 to 20,000 Da. In a preferred example, the polyester oligomer low molecular weight polycarbonate has a weight average molecular weight (Mw) ranging from 1,000 to 10,000 Da.

In one aspect, the low molecular weight polycarbonate comprises low molecular weight aliphatic polycarbonates, low molecular weight aromatic polycarbonates or their combinations.

In one aspect, the recyclable thermoset composition is used for producing epoxy resin, polyurethane resin, phenol-formaldehyde resin, acrylate thermoset resin, polyurethane foam, benzoxazine resin, urea resin, melamine resin, urea formaldehyde resins, vinyl ester resins, polyester resin, polyimide resin, unsaturated polyester resin, polyphenylene oxide based thermoset resin or composite.

In one aspect, the process for recycling the waste thermoset resins is to first decompose the waste thermoset resins in the presence of hydroxyl or amino agents to obtain the decomposed product, and then add the low molecular weight polycarbonate into the decomposed product to form the recyclable thermoset composition.

Accordingly, the invention provides a novel recyclable thermoset composition and a unique solution for recycling waste thermoset resins. The recyclable thermoset composition contains a certain amount of polyester oligomer or low molecular weight polycarbonate that assists the thermoset resin to form a homogeneous mixture and catalyzes interactions or reactions between the degrader and the thermoset resin in recycling process. On the other hand, the novel recyclable thermoset composition can be produced from waste thermoset resins, so achieve to purpose of sustainability and zero waste.

### EMBODIMENTS

In a first embodiment, the recyclable thermoset composition comprises 1-50 wt. % of at least one polyester oligomer or low molecular weight polycarbonate and 50-99 wt. % of at least one thermoset resin calculated based on total weight of the recyclable thermoset composition.

In one embodiment, the polyester oligomer or low molecular weight polycarbonate has a number average molecular weight (Mn) ranging from 500 to 5000 g/mol or a weight average molecular weight (Mw) ranging from 200 to 20,000 Da. In a preferred embodiment, the polyester oligomer or low molecular weight polycarbonate has a weight average molecular weight (Mw) ranging from 500 to 10,000 Da.

In one embodiment, the low molecular weight polycarbonate comprises aliphatic polycarbonates, aromatic polycarbonates or their combinations.

In one embodiment, the aliphatic polycarbonate is selected from one of group consisting of poly(trimethylene carbonate) (PTMC), poly(hexamethylene carbonate), poly(cyclohexylene carbonate), poly(ethylene carbonate), poly(propylene carbonate), poly(methyl propylene carbonate), poly(butylene carbonate), poly(hexylene carbonate), poly(epoxycarbonate), poly(1,2-glycerol carbonate), poly(benzyl 1,2-glycerol carbonates), poly((isopropylidene glyceryl glycidyl ether)-co-(glycidyl methyl ether) carbonate), poly(ether carbonate), poly(ethylene oxide carbonate), poly(propylene oxide carbonate), poly(tetramethylene oxide carbonate), poly(ester carbonate), poly(aromatic ester carbonate), poly(butadiene carbonate), poly(polyacrylate carbonate), poly(siloxane carbonate) and their mixture.

In one embodiment, the aromatic polycarbonate comprises bisphenol A type polycarbonate, bisphenol F type polycarbonate or its combination.

In one embodiment, the aromatic polycarbonates generally contain bulky aromatic benzene rings and quaternary carbon atoms between the carbonate linkages as shown formula (1) and (2).

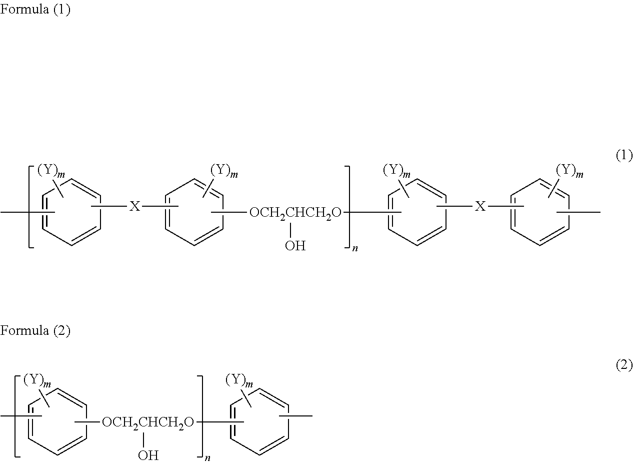

In one embodiment, X independently represents a alkyl group with carbon number is less than or equal to 10, a cycloalkyl group, a halogen substituted alkyl group, a carbonyl group, a sulfonyl group, a sulfinyl group or a polyphenolic group. Y independently represents H, a alkyl group with carbon numbers is less than or equal to 5, a cycloalkyl group, a halogen substituted alkyl group, a carbonyl group, a sulfonyl group, a sulfinyl group or a polyphenolic group. m is an integer of 1~4; and n is an integer of 1~50.

In one embodiment, the thermoset resin comprises polyurethane resin, epoxy resin, phenol-formaldehyde resin, benzoxazine resin, acrylate resin, urea resin, melamine resin, polyester resin, polyimide resin, polyamides resins, bismaleimide resins, urea formaldehyde resins, vinyl ester resins, silicone resins, unsaturated polyester resin, polyphenylene oxide based thermoset resin or their combinations.

In another embodiment, the recyclable thermoset composition comprises 2-50 wt. % of polyester oligomer or low molecular weight polycarbonate and 55-98 wt. % of the thermoset resin. The thermoset resin comprises polyurethane resin, epoxy resin, phenol-formaldehyde resin, benzoxazine resin, acrylate resin, urea resin, melamine resin, polyester resin, polyimide resin, polyamides resins, bismaleimide resins, urea formaldehyde resins, vinyl ester resins, silicone resins, unsaturated polyester resin, polyphenylene oxide based thermoset resin or their combination.

In one representative embodiment, the recyclable thermoset composition comprises 5-45 wt. % of polyester oligomer or low molecular weight bisphenol-A type polycarbonate and 55-95 wt. % of epoxy resin.

In one representative embodiment, the recyclable thermoset composition comprises 5-70 wt. % of polyester oligomer or low molecular weight aromatic polycarbonate and 30-95 wt. % of phenolic-formaldehyde resin.

In one representative embodiment, the recyclable thermoset composition comprises 5-30 wt. % of polyester oligomer or low molecular weight aromatic polycarbonate and 70-95 wt. % of unsaturated polyester resin.

In still one representative embodiment, the recyclable thermoset composition comprises 5-50 wt. % of polyester oligomer or low molecular weight aliphatic polycarbonate and 50-95 wt. % of polyphenylene oxide based thermoset resin.

In one representative example, the recyclable thermoset composition comprises at least one low molecular weight aromatic polycarbonate and an epoxy resin. The recyclable thermoset composition was heated from 50 to 250° C. in the presence of ethanolamine for obtaining a decomposed product. After 3 hours, the recyclable thermoset composition was completely dissolved in the solution and separated from the fillers. FTIR of the decomposed product (KBr) results were shown as follows: IR (cm⁻¹, KBr): 3200-3450 (—OH of phenol and —COONH), 1730-1780 (—C═O (carbonate), 1700-1750 (C═O (carbamate), 1650-1700 (—C═O (urea), 1000-1300 (epoxide).

The decomposed product was mixed with another epoxy resin (NPEL-128), and then cured by heating to obtain a new epoxy resin. The new epoxy resin has a similar FTIR spectrum to the original recyclable thermoset composition. Accordingly, the original recyclable thermoset composition is capable of being totally recycling.

In another representative example, the recyclable thermoset composition comprises at least one low molecular weight aliphatic polycarbonate and a polyurethanes thermoset resin. The recyclable thermoset composition was heated from 50 to 250° C. in the presence of degraders such as ethanolamine for obtaining a decomposed product. After 3 hours, the recyclable thermoset composition was completely dissolved in the solution and separated from the fillers. FTIR of the decomposed product (KBr) results were shown as follows: IR (cm-1, KBr): 3200-3450 (—OH of phenol and —COONH), 1730-1780 (—C═O (carbonate), 1700-1750 (C═O (carbamate), 1700-1730 (carbonate), 1650-1700 (—C═O (urea), 1000-1300 (C═O of carbamate).

The decomposed product was mixed with another polyurethane thermoset resins, and then cured by heating to obtain a new polyurethane based thermoset resin. The new polyurethane based thermoset resin has a similar FTIR spectrum to the original recyclable thermoset composition. Accordingly, the original recyclable thermoset composition is capable of being totally recycling.

In a third representative example, the recyclable thermoset composition comprises at least one low molecular weight aromatic polycarbonate and an unsaturated polyester resin. The recyclable thermoset composition was heated from 50 to 250° C. in the presence of degraders such as ethanolamine for obtaining a decomposed product. The recyclable thermoset composition was completely dissolved in the solution and separated from the fillers. FTIR of the decomposed product (KBr) results were shown as follows: IR (cm-1, KBr): 3200-3600 (—OH of phenol and —COONH), 1730-1780 (—C═O (carbonate), 1720-1740 (—C═O (ester), 1700-1750 (C═O (carbamate), 1650-1700 (—C═O (urea), 1600-1640 (unsaturation functional group).

The decomposed product was mixed with another unsaturated polyester thermoset resins, and then cured by heating to obtain a new unsaturated polyester thermoset resin. The new unsaturated polyester thermoset resin has a similar FTIR spectrum to the original recyclable thermoset composition. Accordingly, the original recyclable thermoset composition is capable of being totally recycling.

In a second embodiment, a process for making recyclable thermoset composition from waste thermoset resins is provided. The process comprises following steps.
Step 1, decompose waste thermoset resin (via recyclable thermoset composition) in the presence of degraders to generate a decomposed product.
Step 2, mix at least one polyester oligomer or low molecular weight polycarbonate with the decomposed product to obtain a recyclable thermoset composition, wherein the polyester oligomer or low molecular weight polycarbonate has a number average molecular weight (Mn) ranging from 500 to 5000 g/mol or a weight average molecular weight (Mw) ranging from 200 to 20,000 Da, and the recyclable thermoset composition comprises 1-50 wt. % of the polyester oligomer or low molecular weight polycarbonate calculated based on total weight of the recyclable thermoset composition.

In one embodiment, the waste thermoset resin (via recyclable thermoset composition) comprises waste polyurethane resin, waste epoxy resin, waste phenol-formaldehyde resin, waste benzoxazine resin, waste acrylate resin, waste urea resin, waste melamine resin, waste polyester resin, waste polyimide resin, waste polyamides resins, waste bismaleimide resins, waste urea formaldehyde resins, waste vinyl ester resins, waste silicone resins, waste unsaturated polyester resin, waste polyphenylene oxide based thermoset resin or their combination.

In one embodiment, the degrader comprises an alkaline substance selected from inorganic bases (including sodium hydroxide, potassium hydroxide, lithium hydroxide, calcium hydroxide, magnesium hydroxide, ammonium hydroxide), alkaline carbonates or bicarbonates, alkaline alkoxides (including sodium methoxide, sodium ethoxide, potassium tert-butoxide), organic amines such as aliphatic primary amines, aliphatic secondary amines, aliphatic tertiary amines, amino alcohols, polyamines, aromatic amines, heterocyclic amines.

In one embodiment, organic amines including monoethanolamine, diethanolamine, triethanolamine, ethylenediamine, diethylenetriamine, methylamine, ethylamine, propylamine, isopropylamine, butylamine, sec-butylamine, tert-butylamine, pentylamine, hexylamine, cyclohexylamine, benzylamine, aniline, toluidine, xylidine, dipropylamine, dibutylamine, diisopropylamine, diethylamine, dimethylamine, trimethylamine, triethylamine, tributylamine, N-methylbutylamine, N-ethylbutylamine, N-methylcyclohexylamine, N,N-dimethylcyclohexylamine, N,N-diethylcyclohexylamine, morpholine, piperidine, piperazine, N-methylpiperazine, N-ethylpiperazine, N-phenylpiperazine, imidazole, 1-methylimidazole, 1-ethylimidazole, pyridine, 2-methylpyridine, 4-methylpyridine, 2-ethylpyridine, 2-aminopyridine, 4-aminopyridine, triethylenetetramine, tetraethylenepentamine, N-methylethanolamine, N-ethylethanolamine, N-propylethanolamine, N-butylethanolamine, tris(2-aminoethyl)amine, heptylamine, octylamine, nonylamine, decylamine, dodecylamine, hexadecylamine, oleylamine, allylamine, propargylamine, ethanolamine, isopropanolamine, 2-amino-1-butanol, 3-amino-1-propanol, 2-amino-2-methyl-1-propanol (AMP), 2-amino-2-ethyl-1,3-propanediol, N,N-dimethylethanolamine (DMEA), N,N-diethylethanolamine (DEEA), N-methyldiethanolamine (MDEA), N-ethyldiethanolamine, N-butyldiethanolamine, N,N-dimethylisopropanolamine, 1,3-diaminopropane, N,N-diethylisopropanolamine, 1,2-diaminopropane, 1,4-diaminobutane (putrescine), 1,5-diaminopentane (cadaverine), 1,6-diaminohexane (hexamethylenediamine), 1,8-diaminooctane, 1,10-diaminodecane, spermidine, spermine, N-methylpiperidine, N-ethylpiperidine, N-benzylpiperidine, quinoline, isoquinoline, 4-dimethylaminopyridine (DMAP), 2-picolylamine, 4-picolylamine, 2-(dimethylamino) ethanol, 2-(diethylamino) ethanol, N,N-dimethylbenzylamine, N,N-diethylbenzylamine, N,N-dimethylaniline, N,N-diethylaniline, or any combination thereof), quaternary ammonium hydroxides, or any combination thereof.

In one embodiment, the low molecular weight polycarbonate comprises aliphatic polycarbonate, aromatic polycarbonate or their combination.

In one embodiment, the aliphatic polycarbonate is selected from one of group consisting of poly(trimethylene carbonate) (PTMC), poly(hexamethylene carbonate), poly(cyclohexylene carbonate), poly(ethylene carbonate), poly(propylene carbonate), poly(methyl propylene carbonate), poly(butylene carbonate), poly(hexylene carbonate), poly(epoxycarbonate), poly(1,2-glycerol carbonate), poly(benzyl 1,2-glycerol carbonates), poly((isopropylidene glyceryl glycidyl ether)-co-(glycidyl methyl ether) carbonate), poly(ether carbonate), poly(ethylene oxide carbonate), poly(propylene oxide carbonate), poly(tetramethylene oxide carbonate), poly(ester carbonate), poly(aromatic ester carbonate), poly(butadiene carbonate), poly(polyacrylate carbonate), poly(siloxane carbonate) and their mixture.

In one embodiment, the aromatic polycarbonate comprises bisphenol A type polycarbonate, bisphenol F type polycarbonate or their combination.

In one embodiment, the aromatic polycarbonates generally contain bulky aromatic benzene rings and quaternary carbon atoms between the carbonate linkages as shown formula (1) and (2).

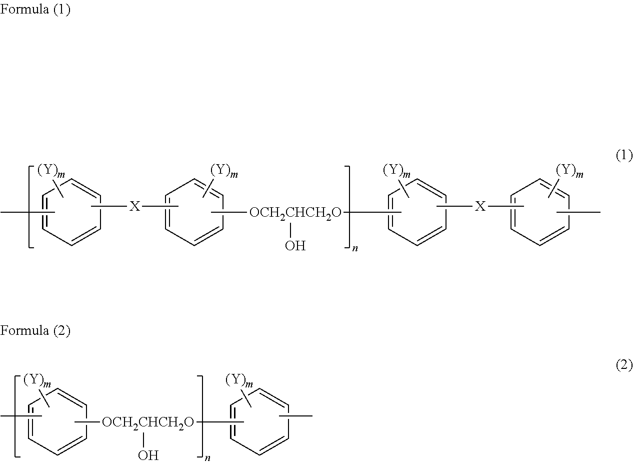

In one embodiment, X independently represents a alkyl group with carbon numbers is less than or equal to 10, a cycloalkyl group, a halogen substituted alkyl group, a carbonyl group, a sulfonyl group, a sulfinyl group or a polyphenolic group. Y independently represents H, a alkyl group with carbon numbers is less than or equal to 5, a cycloalkyl group, a halogen substituted alkyl group, a carbonyl group, a sulfonyl group, a sulfinyl group or a polyphenolic group. m is an integer of 1~4; and n is an integer of 1~50.

In another embodiment, the process for making recyclable thermoset composition from waste thermoset resins is directed to a method for recycling waste thermoset resins.

In one representative embodiment, the waste thermoset resin reacts with degraders at temperature higher than 50° C. to obtain the decomposed product. Mix the decomposed product with the low molecular weight polycarbonate to obtain a recyclable thermoset composition.

In one representative embodiment, the recyclable thermoset composition is degraded in the presence of at least one degrader which has at least one hydroxy group or at least one amino group to generate an intermediate product. The intermediate product comprises organic compounds which are capable of recycling.

In a third embodiment, a method for recycling waste thermoset resin is disclosed. Representatively, the method for recycling waste thermoset resin comprises following steps.
Step 1, decompose waste thermoset resin in the presence of degraders to generate a decomposed product. Composition of the decomposed product comprises organic compounds and/or inorganic compounds.

In one embodiment, the organic compounds comprise oligomers derived from the waste thermoset resin.
Step 2, mix at least one polyester oligomer or low molecular weight polycarbonate with the decomposed product to obtain a recyclable thermoset composition.
Step 3, cure the recyclable thermoset composition to produce a regenerated thermoset resin, and achieve purpose of recycling the waste thermoset resin.

In one embodiment, the waste thermoset resin (via recyclable thermoset composition) comprises waste polyurethane resin, waste epoxy resin, waste phenol-formaldehyde resin, waste benzoxazine resin, waste acrylate resin, waste urea resin, waste melamine resin, waste polyester resin, waste polyimide resin, waste polyamides resins, waste bismaleimide resins, waste urea formaldehyde resins, waste vinyl ester resins, waste silicone resins, waste unsaturated polyester resin, waste polyphenylene oxide based thermoset resin or their combination

In one embodiment, the recyclable thermoset composition comprises 1-50 wt. % of the polyester oligomer or low molecular weight polycarbonate and 50-99 wt. % of the decomposed product based on total weight of the recyclable thermoset composition.

In one embodiment, the polyester oligomer or low molecular weight polycarbonate has a number average molecular weight (Mn) ranging from 500 to 5000 g/mol or a weight average molecular weight (Mw) ranging from 500 to 20,000 Da. In a preferred example, the polyester oligomer or low molecular weight polycarbonate has a weight average molecular weight (Mw) ranging from 1,000 to 10,000 Da.

In one embodiment, the low molecular weight polycarbonate comprises low molecular weight aliphatic polycarbonates, low molecular weight aromatic polycarbonates or their combination.

In one representative embodiment, the waste thermoset resin reacts with degraders at temperature higher than 50° C. to obtain the decomposed product. Mix the decomposed product with the low molecular weight polycarbonate to obtain a recyclable thermoset composition.

The recyclable thermoset composition is used for producing epoxy resin, polyurethane resin, phenol-formaldehyde resin, acrylate thermoset resin, polyurethane foam, benzoxazine resin, urea resin, melamine resin, urea formaldehyde resins, vinyl ester resins, polyester resin, polyimide resin, unsaturated polyester resin, polyphenylene oxide based thermoset resin or composite.

### Example: Preparation of Low Molecular Weight Aliphatic Polyesters

In one example, a low molecular weight aliphatic polyester is prepared via melt polycondensation using either (i) transesterification of a diester with a diol or (ii) direct esterification of a diacid with a diol, followed by molecular weight and structural characterization as described below. The resulting polyester exhibits a number average molecular weight ranging from 500 to 5000 g/mol or a weight average molecular weight ranging from 200 to 20 000 Da.
(A) Transesterification route. A mixture of dimethyl adipate (1.00 mol), ethylene glycol (2.20-2.50 mol), and a catalyst such as zinc acetate or titanium (IV) butoxide (0.01-0.10 mol %) is charged into a nitrogen-purged reactor equipped with mechanical stirring and a distillation column. The mixture is heated to 150-180° C. to initiate transesterification, during which methanol is continuously removed. After substantial methanol evolution, the temperature is increased to 190-210° C. and the pressure is gradually reduced (5-50 mbar) to promote polycondensation and removal of excess glycol. The reaction is terminated when the melt viscosity corresponds to the desired molecular weight range. The polyester melt is discharged, cooled, and collected as a solid or viscous liquid.
(B) Direct esterification (dehydration) route. In the first step of esterification and water removal, the mixture is heated to about 150-190° C. under nitrogen with efficient stirring. Water formed during esterification is removed by azeotropic distillation (optionally in the presence of a high-boiling solvent such as xylene) or by direct distillation through a Dean-Stark trap. The reaction is continued until the acid value drops to a low level (for example <10 mg KOH/g), indicating high conversion of carboxylic acid groups. In the second step of polycondensation under reduced pressure, after most of the water is removed, the temperature is raised to about 190-220° C. and the system is gradually placed under reduced pressure (for example 5-50 mbar) to remove residual water and excess ethylene glycol, thereby driving the polycondensation toward formation of low molecular weight polyester. The reaction is terminated when the target viscosity or molecular weight range (for example≈500-5 000 g/mol) is reached. The product is cooled and isolated as a solid or viscous liquid. The polyester is dissolved in THF or chloroform and analyzed at 30-40° C. using polystyrene standards using Gel Permeation Chromatography (GPC/SEC). The resulting materials exhibit a number average molecular weight ranging from 500 to 5000 g/mol or a weight average molecular weight ranging from 200 to 20 000 Da, with PDI typically between 1.2 and 2.8. ¹H-NMR: O—CH at 3.5-4.8 ppm; CO—CH₂ at 2.2-2.6 ppm; aliphatic CH at 1.2-1.8 ppm; ¹³C-NMR: carbonyl at 175-145 ppm. FTIR Spectroscopy: carbonyl at 1680-1760 cm⁻¹.

### Example: Preparation of Low Molecular Weight Aromatic Polyesters

(A) Transesterification route. A mixture of dimethyl terephthalate (DMT, 1.00 mol), ethylene glycol (EG, 2.20-2.50 mol), and a catalyst such as zinc acetate, manganese acetate, cobalt acetate, or titanium (IV) butoxide (0.01-0.10 mol %) is charged into a nitrogen-purged reactor equipped with mechanical stirring and a distillation column. The mixture is heated to 160-200° C. to initiate transesterification, during which methanol is continuously distilled off. After most methanol is removed (typically 2-4 h), the temperature is increased to 220-250° C., and the pressure is gradually reduced to 5-50 mbar to promote polycondensation and removal of excess glycol. The reaction is terminated when the melt viscosity corresponds to the desired molecular weight range. The aromatic polyester melt is discharged, cooled, and collected as a brittle solid or granulated flakes.
(B) Direct esterification (dehydration) route. A mixture of terephthalic acid (TPA, 1.00 mol), ethylene glycol (2.20-2.50 mol), and an esterification catalyst (e.g., p-toluenesulfonic acid, sulfuric acid, or tin (II) octoate) is heated to 180-230° C. under nitrogen. Water generated during esterification is removed by direct distillation or via a Dean-Stark trap. When the acid value decreases to <10 mg KOH/g, the temperature is raised to 230-260° C. and the pressure is reduced (5-50 mbar) to drive polycondensation. The reaction is stopped when the target molecular weight is achieved. This method yields low molecular weight aromatic polyesters such as poly(ethylene terephthalate) oligomers, poly(butylene terephthalate) oligomers, or polyarylate oligomers depending on the selected diol. The reaction is terminated when the target viscosity or molecular weight range (for example≈ 500-5 000 g/mol) is reached. The product is cooled and isolated as a solid or viscous liquid. The polyester is dissolved in THF or chloroform and analyzed at 30-40° C. using polystyrene standards using Gel Permeation Chromatography (GPC/SEC). The resulting materials exhibit a number average molecular weight ranging from 500 to 5000 g/mol or a weight average molecular weight ranging from 200 to 20 000 Da, with PDI typically between 1.2 and 2.8. ¹H-NMR: aromatic protons at 6.6-8.3 ppm, O—CH at 3.6-4.9 ppm; CO—CH₂ at 2.2-2.6 ppm; aliphatic CH at 1.2-2.5 ppm; ¹³C-NMR: carbonyl at 175-145 ppm, aromatic carbons at 120-140 ppm. FTIR Spectroscopy: carbonyl at 1680-1760 cm⁻¹.

### Example: General Process for Making Recyclable Thermoset Composition Using Low Molecular Weight Aliphatic or Aromatic Polyesters

In one example, a recyclable thermoset composition is prepared by blending or reacting a low molecular weight aliphatic or aromatic polyester with a thermoset resin or waste thermoset resin. The thermoset resin may include polyurethane resin, waste epoxy resin, waste phenol-formaldehyde resin, waste benzoxazine resin, waste acrylate resin, waste urea resin, waste melamine resin, waste polyester resin, waste polyimide resin, waste polyamide resins, waste bismaleimide resins, waste urea-formaldehyde resins, waste vinyl ester resins, waste silicone resins, waste unsaturated polyester resin, waste polyphenylene oxide-based thermoset resin, or any combination thereof. The low molecular weight polyester used in this example exhibits a number average molecular weight ranging from 500 to 5000 g/mol or a weight average molecular weight ranging from 200 to 20 000 Da.

### General Reactive Incorporation Process

A low molecular weight polyester (aliphatic or aromatic), a thermoset resin or its waste form (powder, flakes, granules), and a catalyst capable of promoting ester-exchange, transesterification, transcarbonation, aminolysis, or alcoholysis reactions are charged into a reactor. Suitable catalysts include zinc acetate, tin (II) octoate, titanium (IV) butoxide; tertiary amines, quaternary ammonium salts; organophosphates, organotin catalysts; metal acetylacetonates. The mixture is mixed and heated to 70-270° C. under nitrogen with mechanical stirring. Depending on the chemistry of the thermoset resin, the following reactions may occur. Transesterification with polyester or vinyl ester networks; transcarbonation with polycarbonate-containing networks; alcoholysis/glycolysis of epoxy, polyurethane, or polyester networks; aminolysis of polyamide, polyurethane, or bismaleimide networks; ether-exchange with h phenol-formaldehyde or benzoxazine networks; siloxane-exchange for silicone-based thermosets. The low molecular weight polyester acts as a reactive chain-transfer agent, partially cleaving and reconnecting the thermoset network to form a dynamic covalent network capable of reprocessing. The system may be subjected to reduced pressure (5-100 mbar) to remove alcohols, glycols, phenols, or other small molecules generated during bond-exchange reactions. FTIR Spectroscopy: carbonyl at 1680-1760 cm⁻¹.

Table 1 lists representative formulations for preparing recyclable thermoset compositions.

TABLE 1

| | | Low-MW Polyester | | | Polyester:Resin |
|---|---|---|---|---|---|
| No | Thermoset/Waste Resin | Type | Catalyst | Temp (°C) | (wt %) |
| 1 | Polyurethane resin | Aliphatic polyester | Ti(OBu)₄ | 120-180 | 30:70 |
| | | (Mn 1500) | | | |
| 2 | Epoxy resin | Aromatic polyester | Zn(OAc)₂ | 150-210 | 40:60 |
| | | (Mn 2000) | | | |
| 3 | Phenol-formaldehyde | Aliphatic polyester | Tertiary | 130-190 | 25:75 |
| | resin | (Mn 800) | amine | | |
| 4 | Benzoxazine resin | Aromatic polyester | Zn(OAc)₂ | 170-230 | 35:65 |
| | | (Mn 1200) | | | |
| 5 | Acrylate resin | Aliphatic polyester | Sn(Oct)₂ | 110-170 | 50:50 |
| | | (Mn 3000) | | | |
| 6 | Urea resin | Aromatic polyester | DBU | 140-200 | 40:60 |
| | | (Mn 2500) | | | |
| 7 | Melamine resin | Aliphatic polyester | Phosphoric | 160-220 | 30:70 |
| | | (Mn 1000) | catalyst | | |
| 8 | Polyester resin | Aromatic polyester | Ti(OBu)₄ | 190-250 | 50:50 |
| | | (Mn 1800) | | | |
| 9 | Polyimide resin | Aliphatic polyester | Zn(OAc)₂ | 210-270 | 40:60 |
| | | (Mn 900) | | | |
| 10 | Polyamide resin | Aromatic polyester | DBU | 180-240 | 45:55 |
| | | (Mn 1500) | | | |
| 11 | Bismaleimide resin | Aliphatic polyester | Zn(OAc)₂ | 170-230 | 35:65 |
| | | (Mn 2000) | | | |
| 12 | Urea-formaldehyde resin | Aromatic polyester | Tertiary | 120-180 | 40:60 |
| | | (Mn 3000) | amine | | |
| 13 | Vinyl ester resin | Aliphatic polyester | Sn(Oct)₂ | 140-200 | 50:50 |
| | | (Mn 1200) | | | |
| 14 | Silicone resin | Aromatic polyester | Acid | 100-160 | 30:70 |
| | | (Mn 2500) | catalyst | | |
| 15 | Unsaturated polyester | Aliphatic polyester | Ti(OBu)₄ | 150-210 | 40:60 |
| | resin | (Mn 1500) | | | |
| 16 | Polyphenylene | Aromatic polyester | Strong | 200-260 | 35:65 |
| | oxide-based resin | (Mn 1800) | base | | |
| 17 | Epoxy resin | Aliphatic polyester | Zn(OAc)₂ | 130-190 | 60:40 |
| | | (Mn 500) | | | |
| 18 | Polyurethane resin | Aromatic polyester | Sn(Oct)₂ | 90-150 | 50:50 |
| | | (Mn 4000) | | | |
| 19 | Melamine-formaldehyde | Aliphatic polyester | DBU | 160-220 | 45:55 |
| | resin | (Mn 2500) | | | |
| 20 | Mixed resins (epoxy + | Aromatic polyester | Zn(OAc)₂ + | 180-240 | 50:50 |
| | PU + UPR) | (Mn 3500) | Ti(OBu)₄ | | |

### Recycling Process of the Waste Thermoset Resins Using the Degrader

In a general example, a recycling process for waste thermoset resins is carried out using the degrader described in [0058]. The waste thermoset resin may include any of the thermoset materials listed in [0056], such as polyurethane resin, waste epoxy resin, waste phenol-formaldehyde resin, waste benzoxazine resin, waste acrylate resin, waste urea resin, waste melamine resin, waste polyester resin, waste polyimide resin, waste polyamide resins, waste bismaleimide resins, waste urea-formaldehyde resins, waste vinyl ester resins, waste silicone resins, waste unsaturated polyester resin, waste polyphenylene oxide-based thermoset resin, or any combination thereof.

In a general example, the degrader comprises an alkaline substance selected from inorganic bases (including sodium hydroxide, potassium hydroxide, lithium hydroxide, calcium hydroxide, magnesium hydroxide, ammonium hydroxide), alkaline carbonates or bicarbonates, alkaline alkoxides (including sodium methoxide, sodium ethoxide, potassium tert-butoxide), or organic amines such as aliphatic primary amines, aliphatic secondary amines, aliphatic tertiary amines, amino alcohols, polyamines, aromatic amines, and heterocyclic amines. The waste thermoset resin is collected in the form of flakes, powders, granules, or shredded fragments.

In a general recycling example, the pre-treatment of material is washed, dried at 60-80° C., and optionally ground to a particle size of 0.1-2 mm to increase surface area and improve reaction efficiency.

In the next step of depolymerization using the degrader, the reaction mixture containing: (1) waste thermoset resin (100 parts by weight); (2) degrader (5-50 parts by weight), and (3) optional solvent (e.g., ethylene glycol, propylene glycol, glycerol, water, or alcohols) is charged into a reactor equipped with mechanical stirring, nitrogen inlet, and temperature control. The mixture is heated to 70-260° C., depending on the resin type and the selected alkaline degrader. Representative degradation pathways include: alkaline hydrolysis of ester-containing thermosets (polyester, vinyl ester, acrylate, UPR); alkaline alcoholysis/glycolysis of epoxy, polyurethane, and polyester networks; aminolysis of polyamide, polyurethane, bismaleimide, and urea-based resins; ether-cleavage of phenol-formaldehyde, benzoxazine, and PPO-based resins; carbonate-cleavage of polycarbonate-containing networks; siloxane-cleavage of silicone resins. The alkaline degrader breaks covalent bonds within the thermoset network, converting the crosslinked structure into soluble oligomers or reactive fragments. The system may be subjected to reduced pressure (5-100 mbar) to remove alcohols, glycols, phenols, amines, or other small molecules generated during depolymerization.

In the final recovery and recycled step, after cooling, the reaction mixture may yield soluble oligomers, or partially depolymerized resin fragments. These recycled oligomers or reactive fragments can be used as low molecular weight aliphatic or aromatic polyesters described in for making recyclable thermoset compositions. To prepare a recyclable thermoset composition from the recycled oligomers or reactive fragments, the recycled material is combined with the low molecular weight aliphatic or aromatic polyesters described in at a weight ratio of 5 to 80%, depending on the desired network density and re-processability.

In conclusion, the novel recyclable thermoset composition comprises 1-50 wt. % of polyacyloxy oligomer or low molecular weight polycarbonate and 50-99 wt. % of the thermoset resin. The thermoset resin comprises polyurethane resin, epoxy resin, phenol-formaldehyde resin, benzoxazine resin, acrylate resin, urea resin, melamine resin, polyester resin, polyimide resin, polyamides resins, bismaleimide resins, urea formaldehyde resins, vinyl ester resins, silicone resins, unsaturated polyester resin, polyphenylene oxide based thermoset resin or their combination. The low molecular weight polycarbonate reacts with the thermoset resin in the presence of degraders to form a homogeneous decomposed product in the recycling process. The homogeneous degradation product is used to produce a new recyclable thermoset resin. The new recyclable thermoset resin comprises polyurethane resin, epoxy resin, phenol-formaldehyde resin, benzoxazine resin, acrylate resin, urea resin, melamine resin, polyester resin, polyimide resin, polyamides resins, bismaleimide resins, urea formaldehyde resins, vinyl ester resins, silicone resins, unsaturated polyester resin, polyphenylene oxide based thermoset resin.

Obviously, many modifications and variations are possible in the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A recyclable thermoset composition, comprising 1-50 wt. % of at least one polyacyloxy oligomer or low molecular weight polycarbonate and 50-99 wt. % of at least one thermoset resin calculated based on total weight of the recyclable thermoset composition, wherein the polyacyloxy oligomer or low molecular weight polycarbonate has a number average molecular weight (Mn) ranging from 500 to 5000 g/mol or a weight average molecular weight (Mw) ranging from 200 to 20,000 Da.

2. The recyclable thermoset composition of claim 1, wherein the low molecular weight polycarbonate comprises aliphatic polycarbonate, aromatic polycarbonate or their combinations.

3. The recyclable thermoset composition of claim 2, wherein the aliphatic polycarbonate is selected from one of group consisting of poly(trimethylene carbonate) (PTMC), poly(hexamethylene carbonate), poly(cyclohexylene carbonate), poly(ethylene carbonate), poly(propylene carbonate), poly(methyl propylene carbonate), poly(butylene carbonate), poly(hexylene carbonate), poly(epoxycarbonate), poly(1,2-glycerol carbonate), poly(benzyl 1,2-glycerol carbonates), poly((isopropylidene glyceryl glycidyl ether)-co-(glycidyl methyl ether) carbonate), poly(ether carbonate), poly(ethylene oxide carbonate), poly(propylene oxide carbonate), poly(tetramethylene oxide carbonate), poly(ester carbonate), poly(aromatic ester carbonate), poly(butadiene carbonate), poly(polyacrylate carbonate), poly(siloxane carbonate) and their mixture.

4. The recyclable thermoset composition of claim 2, wherein the aromatic polycarbonate comprises bisphenol A type polycarbonate, bisphenol F type polycarbonate or their combination.

5. The recyclable thermoset composition of claim 1, wherein the thermoset resin comprises polyurethane resin, epoxy resin, phenol-formaldehyde resin, benzoxazine resin, acrylate resin, urea resin, melamine resin, polyester resin, polyimide resin, polyamides resins, bismaleimide resins, urea formaldehyde resins, vinyl ester resins, silicone resins, unsaturated polyester resin, polyphenylene oxide based thermoset resin or their combination.

6. A process for making recyclable thermoset composition from waste thermoset resins, comprising:
decomposing a waste thermoset resin in the presence of a degrader to generate a decomposed product; and
mixing the decomposed product with at least one polyacyloxy oligomer or low molecular weight polycarbonate to make the recyclable thermoset composition, wherein the polyacyloxy oligomer or low molecular weight polycarbonate has a number average molecular weight (Mn) ranging from 500 to 5000 g/mol or a weight average molecular weight (Mw) ranging from 200 to 20,000 Da, and the recyclable thermoset composition comprises 1-50 wt. % of the polyacyloxy oligomer or low molecular weight polycarbonate calculated based on total weight of the recyclable thermoset composition.

7. The process for making recyclable thermoset composition from waste thermoset resins of claim 6, wherein the waste thermoset resin comprises waste polyurethane resin, waste epoxy resin, waste phenol-formaldehyde resin, waste benzoxazine resin, waste acrylate resin, waste urea resin, waste melamine resin, waste polyester resin, waste polyimide resin, waste polyamides resins, waste bismaleimide resins, waste urea formaldehyde resins, waste vinyl ester resins, waste silicone resins, waste unsaturated polyester resin, waste polyphenylene oxide based thermoset resin or their combination.

8. The process for making recyclable thermoset composition from waste thermoset resins of claim 6, wherein the degrader comprises an alkaline substance selected from inorganic bases including sodium hydroxide, potassium hydroxide, lithium hydroxide, calcium hydroxide, magnesium hydroxide, ammonium hydroxide, alkaline carbonates or bicarbonates, alkaline alkoxides including sodium methoxide, sodium ethoxide, potassium tert-butoxide, organic amines such as aliphatic primary amines, aliphatic secondary amines, aliphatic tertiary amines, amino alcohols, polyamines, aromatic amines, heterocyclic amines.

9. The process for making recyclable thermoset composition from waste thermoset resins of claim 6, wherein the low molecular weight polycarbonate comprises aliphatic polycarbonate, aromatic polycarbonate or their combinations.

10. The recyclable thermoset composition of claim 9, wherein the aliphatic polycarbonate is selected from one of group consisting of poly(trimethylene carbonate) (PTMC), poly(hexamethylene carbonate), poly(cyclohexylene carbonate), poly(ethylene carbonate), poly(propylene carbonate), poly(methyl propylene carbonate), poly(butylene carbonate), poly(hexylene carbonate), poly(epoxycarbonate), poly(1,2-glycerol carbonate), poly(benzyl 1,2-glycerol carbonates), poly((isopropylidene glyceryl glycidyl ether)-co-(glycidyl methyl ether) carbonate), poly(ether carbonate), poly(ethylene oxide carbonate), poly(propylene oxide carbonate), poly(tetramethylene oxide carbonate), poly(ester carbonate), poly(aromatic ester carbonate), poly(butadiene carbonate), poly(polyacrylate carbonate), poly(siloxane carbonate) and their mixture.

11. The recyclable thermoset composition of claim 9, wherein the aromatic polycarbonate comprises bisphenol A type polycarbonate, bisphenol F type polycarbonate or their combination.

12. The process for making recyclable thermoset composition from waste thermoset resins of claim 6, being a method for recycling waste thermoset resins.
